(19) United States
(12) Patent Application Publication
(10) Pub. No.: US 2002/0142062 A1
(43) Pub. Date: Oct. 3, 2002

(54) Stack mold and components thereof

(76) Inventor: Glenn Starkey, North Barrington, IL (US)

Correspondence Address: BARNES & THORNBURG, 2600 CHASE PLAZA, 10 LASALLE STREET, CHICAGO, IL, 60603

(21) Appl. No.: 09/885,334

(22) Filed: Jun. 19, 2001

Related U.S. Application Data
(60) Provisional application No. 60/212,247, filed on Jun. 19, 2000.

(51) Int. Cl. B29C 45/66

(52) U.S. Cl. 425/234; 425/589

(57) ABSTRACT

In one embodiment of the invention, an improved stack mold timing and alignment system is provided which includes a gear wheel enclosed within a gear housing, rack spacers which extend between the center section and the two B-halves of the mold. The rack spacers are mounted to the center section and B-halves in a manner which allows a pivoting and floating mount such that the mold has improved tolerance for misalignment. This allows the gear and rack to avoid many misalignment situations which would cause excessive wear and damage to more rigidly mounted gear and rack systems.

This is a continuation-in-part of U.S. Ser. No. 60/212,247, filed Jun. 19, 2000.

### FIELD OF THE INVENTION

The present invention is generally related to the field of guide systems for stack molds. More particularly, the invention is directed to an improved stack mold which is easier to manufacture and maintain in operation.

### BACKGROUND OF THE INVENTION

In simple terms, a stack mold is a mold that has two B-halves (or moveable portions) that together with a center carrier section form article forming cavities when the mold is in the closed position. The use of a stack mold with two B-halves increases the number of articles that can be formed with a given mold press per mold cycle relative to conventional molds having only a core-half and a cavity half spacing. A stack mold typically uses a rack and gear system to attempt to keep proper timing between the center section during opening and closing of the B-halves and center section. This allows the mold to open and close with both halves moving simultaneously at the proper speed and distance toward and away from the center section of the mold during the molding cycle such that the meeting of the B-halves and center section is synchronized. The gear housing is typically mounted to the center section and the racks are mounted to the B-halves.

Prior stack molds suffered from several problems including complexity of custom design as well as requiring multiple precision machined components. For this reason, many mold builders have turned to specialized independent contractors to custom-make stack molds when the need arises to manufacture one.

Moreover, the prior art stack molds typically mounted the rack spacers rigidly to each of the B-halves. The rack spacers were typically not precision machine parts due to their size and heft and cost of precision machining such a large and heavy component. Therefore, the rigid mounting of the B-halves and their imperfections, including twists, bends and deviations for specifications, can cause the stack mold to become mistimed such that both B-halves do not meet the center carrier section simultaneously as is intended. This can cause wear and damage to the stack mold and can result in production of interior product and/or can cause product to jam in the machine.

One problem with current stack mold systems is that, when a stack mold becomes jammed, the rack and gear system will frequently become heavily damaged, and in some cases, the gears may shear off of the gear wheel. Such damage is expensive and time consuming to repair.

Furthermore, it has been found that careless workers may become injured due to having clothing or appendages stuck between the gears and racks of the prior stack molds. Thus, there is a need for a safer design for a rack and gear to drive a stack mold.

Prior gear wheel and rack spacer timing systems typically required far more precision machining and alignment than is desirable. For instance, precision machining was required for mounting the gear wheel and the gear plates commonly used to guide the rack spacers in their movement along the gear wheel. Moreover, as the rack spacers were commonly rigidly mounted to the B-mold halves, their position fairly precisely aligned such that precision milling was usually necessary. Also, the mold maker often had to customize the gear mount. Since typical commercial gears are usually not suitable without modification. Typically, such gear wheels are mounted to a drive axle that is designed to spin only when driven. Thus, mold maker will frequently need to re-bore out the center of the gear to a larger diameter to be able to place a bearing inside of the gear to allow the gear to freely spin on an axle.

A further problem with conventional stack mold construction is the process of connecting an ejector plate actuator to the ejector plate. Typically, the connection to the ejector plate required the manufacture of a threaded bore within the plate for receipt of a threaded coupling between the actuating source and the ejector plate. This process required additional precision machining.

Another problem with prior stack mold construction was the fabrication of a center support to mount to the frame of the injection mold press. Typically, the mold maker would need information from his customer concerning the type of press and the dimensions of the tie bars of the press frame to custom fabricate a support system to bear the weight of the center portion of the stack mold on the tie bars. Such center supports were typically slidably mounted to the tie bars by use of precision machined pads. Each center support was typically custom machined by the mold maker to fit the mold being manufactured and the intended press for its use. For these reasons, the fabrication of such center support typically has included a large amount of customer precision machining by the mold maker.

Many mold makers have become so frustrated with the complexity of stack mold projects fabrication that they have sworn off making them in their shops and have resorted to having them custom made at great expense by a third party contractor specializing in such precision work. There is a need for a stack mold system which eases the process of manufacture of a stack mold, which eases mold maintenance and which results in the manufacture of more durable stack molds.

Another problem with prior custom designed stack mold systems is that they are typically custom fabricated for use on only one specific type of mold press. This typically results from the prior stack molds' complex means of connection to the press frame and complex mold timing and alignment systems which are not readily adaptable for use in any other style of mold press. Therefore, such molds are frequently under-utilized since they can only be used with certain presses within a manufacturer's facilities. This causes production scheduling problems where a part manufacturer must idle a stack mold when the mold press it is specifically adapted to is needed for a higher priority job. Moreover, if the part manufacturer wishes to ship custom stack molds to an alternate facility having different size, style or model of mold press, prior stack molds were difficult or impossible to modify for use in such presses. Accordingly, it would be advantageous to have a stack mold which could be readily adapted to use on a variety of mold presses of a variety of different sizes, models and styles.

### SUMMARY OF INVENTION

In one embodiment of the invention, an improved stack mold timing and alignment system is provided which includes a gear wheel enclosed within a gear housing, rack spacers which extend between the center section and the two B-halves of the mold. The rack spacers are mounted to the center section and B-halves in a manner which allows a pivoting and floating mount such that the mold has improved tolerance for misalignment. This allows the gear and rack to avoid many misalignment situations which would cause excessive wear and damage to more rigidly mounted gear and rack systems.

In one preferred embodiment of the invention, a securing dowel pins are used to secure the rack spacers to the B-halves which are engineered to serve as the breakaway piece. Such a break-away dowel pin prevents the gears on the gear wheel and rack spacers from shearing. Replacement of the dowel is far less expensive than repairing or replacing a damaged gear wheel or spacer bar.

In another embodiment of the invention, a novel rack spacer mounting system is provided in which mounting plates for engaging the rack spacer are secured only at a corner location such that, should there be binding or jamming within the mold, the dowel pin, which is easy to replace, would shear before the gears would. The mounting plates are preferably secured by mounting screws at an opposite peripheral location to the adjacent plate engaging a rack spacer. The other end of the rack spacer is engaged by the gear wheel and is held in place by cam followers. The use of cam followers also contributes to the floating mount which is forgiving of misalignment.

Gears shearing would result in costly damage within the gear housing, and the design of the rack spacers lessens the strain on the entire system, while also preventing significant damage.

In another embodiment of the invention, an improved stack mold is provided having a mold center portion; a center support for slidably mounting the mold center portion to the press frame; a gear assembly adapted to mount in a pocket formed in the mold center portion; a plurality of moveable mold portions which open and close relative to the center portion; a plurality of racks have first and second ends, the first ends of the racks being slidably mounted to the gear assembly, the second end of the racks being mounted to one of the plurality of moldable mold portions; and a plurality of rack spacers for mounting the second end of the plurality of racks to the plurality of moveable mold portions. In one preferred aspect of such stack mold, the center support section is detachably coupled to the mold portion by a plurality of bolts extending from the center portion into the center section of the mold. Further, detachable tie bar pads are provided which may be adapted to the shape and size of tie bar pads used by a variety of different mold presses. By use of the detachably coupled center support section and the flexible tie bar pads, the stack mold may be removed from the press and used in another press of a different style, size or model using the same center support section with modified tie bar pads or blocks or with a newly manufactured support section. This flexibility increases the mold end users ability to accommodate a fluctuating production schedule.

### DESCRIPTION OF THE DRAWINGS

FIG. 1 is a side view of the mold timing system of the present invention installed on a stack mold with the mold in a closed position.

FIG. 2 is a front plan view of the gear box of one embodiment of the invention with the cover removed.

FIG. 3 is a cross-sectional view of the gear box of FIG. 2 with the cover attached.

FIG. 4 is a side view of the timing system of one embodiment of the invention shown installed in a stack mold with the mold in an open position.

FIG. 5 is a perspective view of the stack mold in accordance with one embodiment of the invention.

FIG. 6 is a side view of mold B-halves, hydraulic actuator and ejector plate in accordance with one embodiment of the invention.

FIG. 7 is a top view of the pin plate coupling in accordance with one embodiment of the invention.

FIG. 8 is a side view of the pin plate coupling in accordance with one embodiment of the invention.

### DETAILED DESCRIPTION OF THE PREFERRED EMBODIMENT

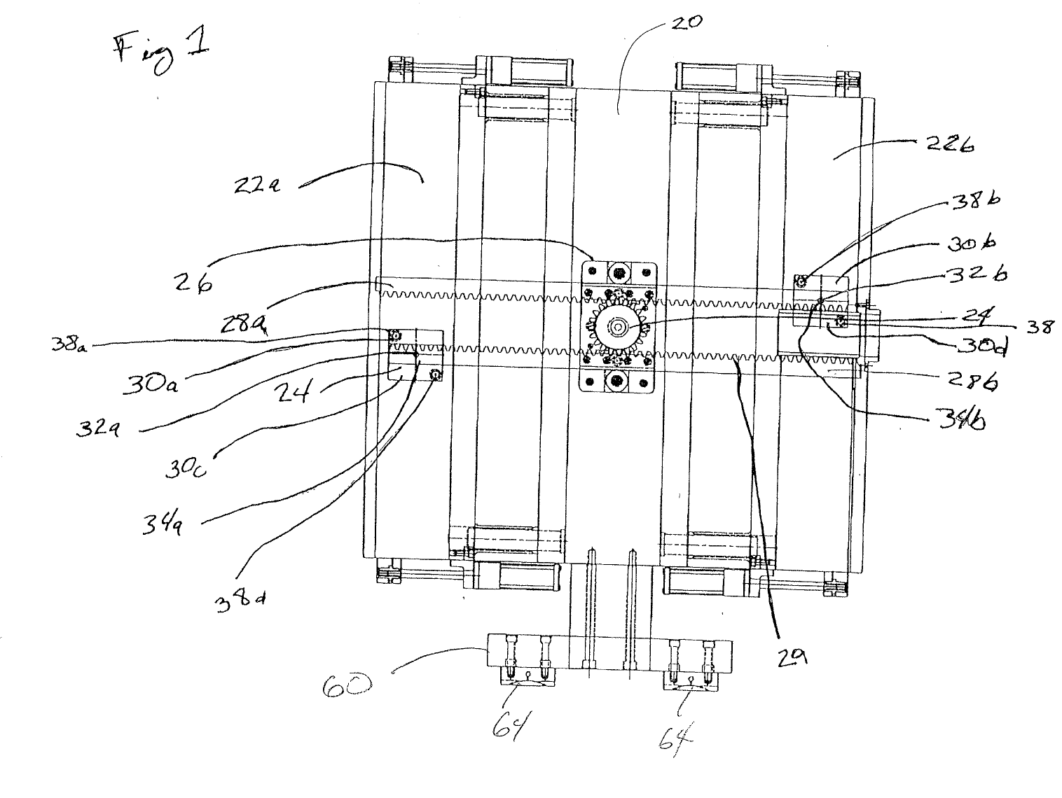

One embodiment of the stack mold components is shown in FIG. 1. FIG. 1 generally depicts a mold center portion 20 and mold B-halves or moveable mold portions 22a and 22b. The opening and closing of the mold halves 22a and 22b are synchronized by virtue of mold timing system 24 which includes a gear housing 26 mounted to the center portion 20, rack spacers 28a and 28b which are mounted to B-halves 22a and 22b by plate pairs 30a-b and 30c-d as well as dowel pins 32a and 32b. The dowel pins 32a and 32b are seating in an aperture machined into the rack spacers 28a and 28b and a corresponding hole machined in the B-halves 22a and 22b. Mounting plates 30a-d are mounted to the B-half by means of screws 36a-d which are mounted in opposite peripheral corners on the plate pairs 30a-d securing each rack spacer 28a and 28b. The screws 36a-d are mounted into threaded holes machined into the B-halves 22a and 22b.

The placement of the screws 36a-d at the opposite peripheral corners of the mounting plates 30a-d allows for pivotal movement of the plate and thereby provide some flexibility to the mount of the rack spacers 28a and 28b on the B-halves 22a and 22b. Furthermore, since the dowel pins 32a and 32b are the only mounting apparatus which spans rack spacers 28a and 28b, in the event of a jam or other malfunction, the dowel pins will shear so that significant damage to the gear box and ratchet teeth 29 of the rack spacers is avoided.

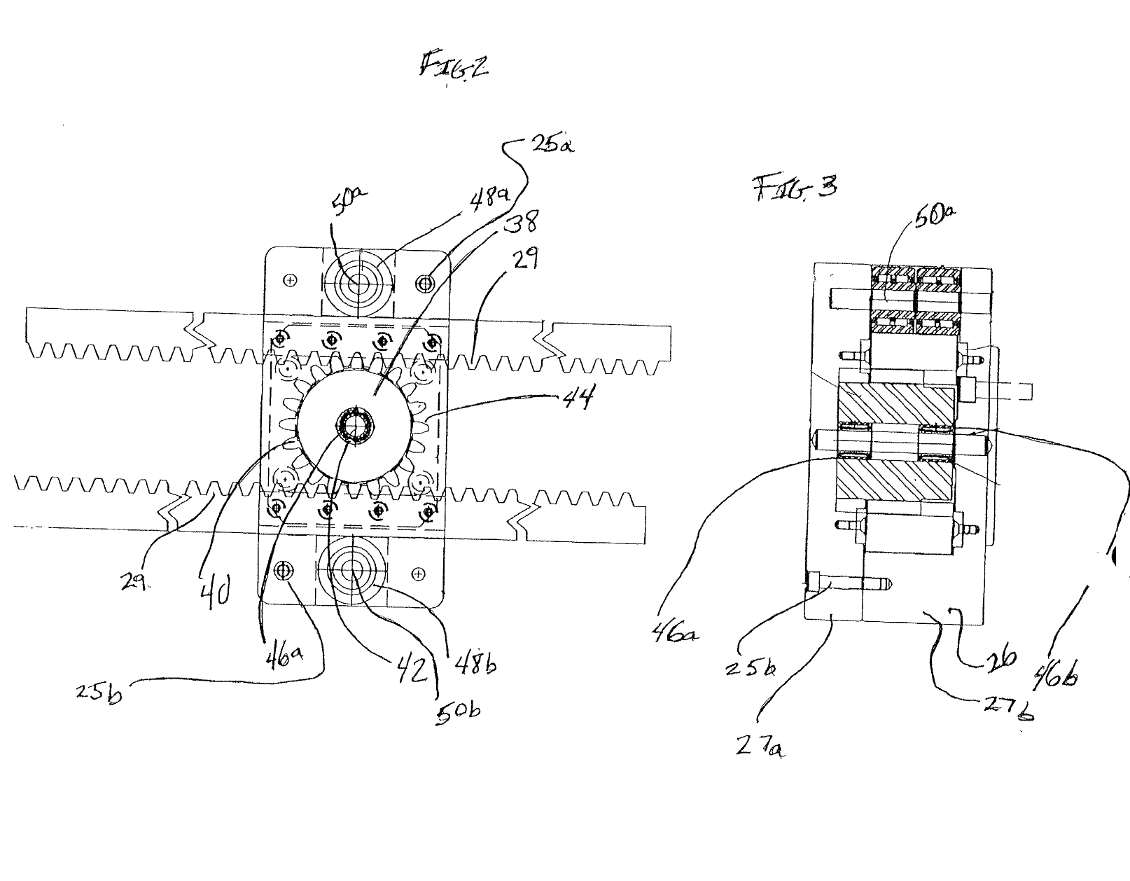

The gear housing and gear works can be best seen in FIGS. 2 and 3. The gear housing 26 enclosed a gear wheel 38 having gear teeth 43 dimensioned to engage ratchet teeth 29 formed in the surface of the rack spacers 28a and 28b. The gear wheel 28 is mounted in the gear housing by dowel pin 42. A wear plate 44 is mounted behind the gear wheel 38 and the dowel pin 42 is rotatably mounted in the housing by means of the dowel pin engaging roller bearings 46a and 46b. The rack spacers 28a and 28b are held against the gear wheel 40 by means of cam followers 48a and 48b. The cam followers 48a and 48b are mounted in the gear housing by dowel pins 50a and 50b. The use of cam followers 48a and 48b reduces wear on the rack spacers 28a and 28b and provides a flexible mounting in which the gear wheel and rack spacers are held in place without excessive force binding or wear on either the gear or the rack spacers. The gear housing 26 is comprised of gear plates 27a and 27b which have a threaded bore aligned between the halves for receiving a socket-headed cap screw for sealing the housing halves against one another.

To install the timing system of the present invention involved far less precision machining and precision alignment than prior gear wheel and rack spacer systems. This is so because the gear wheel is installed by first machining a shallow pocket in the exterior of the mold center portion 20. The gear box is then mounted using four screw holes milled into the shallow pocket for receiving four mounting screws to mount the gear box. The rack spacers are then inserted into the appropriate slot and engage the gear teeth 43 with ratchet teeth 29 of the rack spacers 28a and 28b. The ends of the rack spacers 28a and 28b are then attached to the B-halves by installing mounting plates 30a-d and milling a threaded bore into the B-half for receiving screws 36a-d. Lastly, the holes for the dowel pins 32a and 32b are milled through the rack spacers into the B-halves 22a and 22b for receiving the dowel pins 32a and 32b. Thus, as illustrated above, the alignment and timing system of the present invention eliminates many steps of precision milling and alignment which were associated with prior methods of installing wheel gear and rack spacer timing systems.

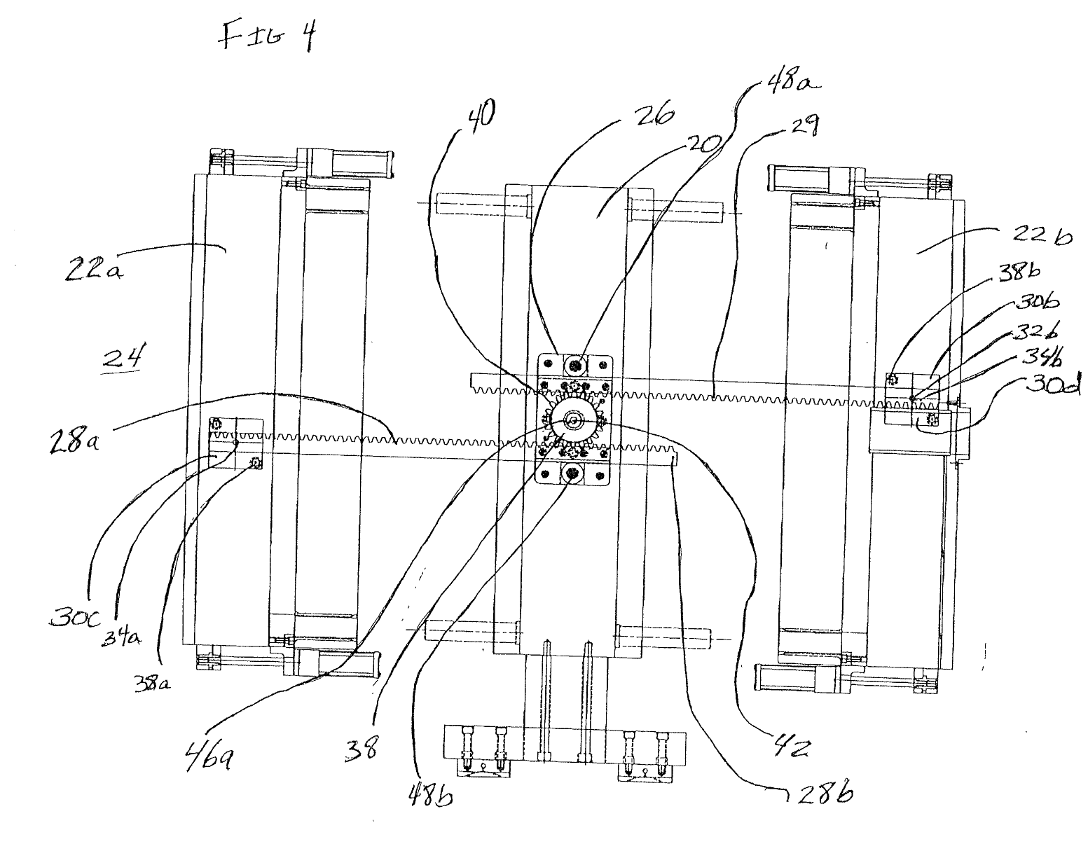

As can be seen by comparison of FIG. 1 and FIG. 4, in use, the engagement of the gear wheel 32 and its gear teeth 43 with the rack spacers 28a and 28b and their rachet teeth 29 ensures that the B-halves 22a and 22b move synchronously back between mold open position, as shown in FIG. 4 and a mold closed position as shown in FIG. 1.

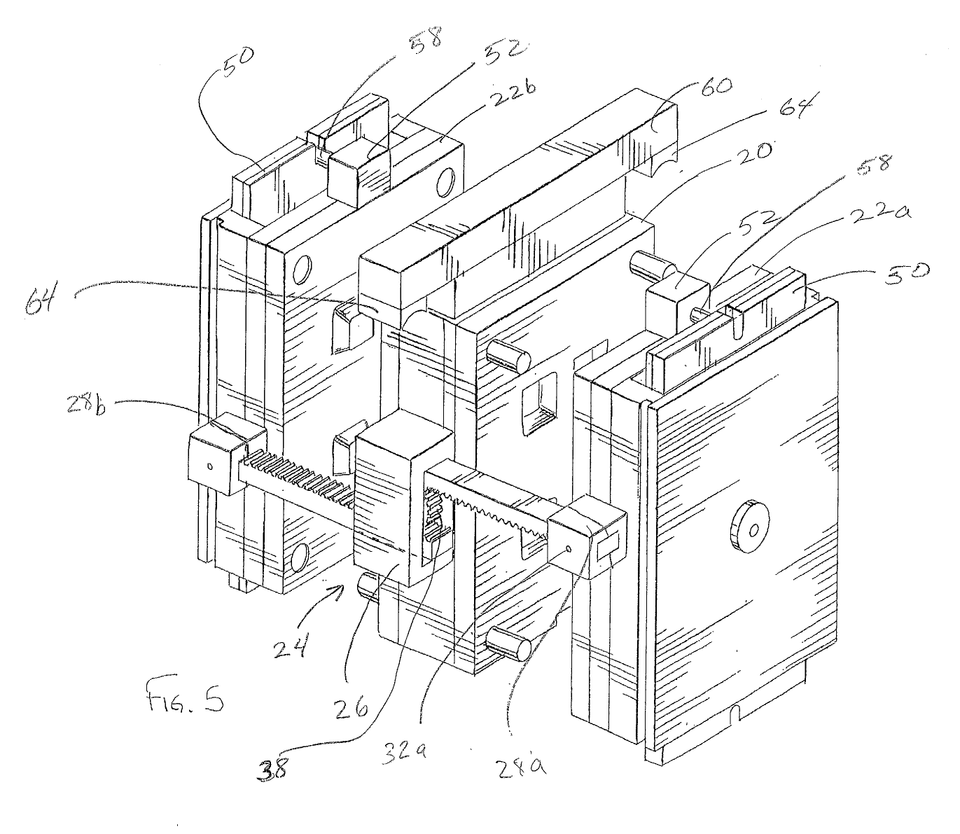

As can be best seen in FIGS. 1 and 5, a center support 60 is detachably mounted to the center portion by a plurality of bolts 62. The tie bar pads 64 are provided on center support 20 to engage the press frame at tie bars (not shown). This allows the frame to support the weight of the stack mold.

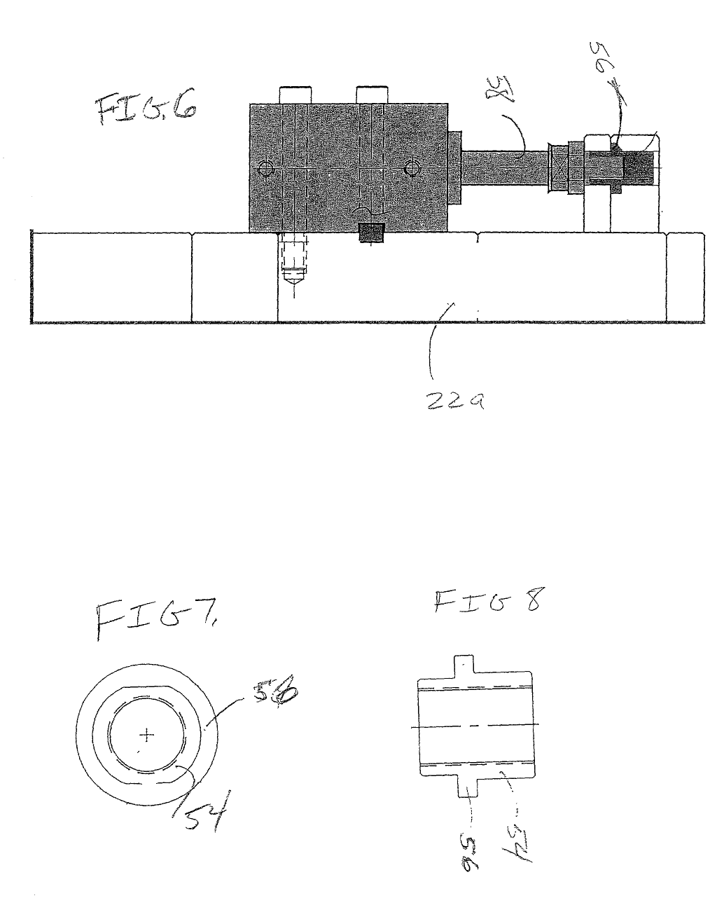

As can be best seen in FIGS. 6, 7 and 8, the ejector plate 50 and pin plate 52 are connected for movement within each mold B-half 22a and 22b. The ejector plate and pin plate are connected to cylinders 52 by pin plate coupling 54. The coupling is threadless and has a shoulder 56 formed therein for engagement with the slot and either the ejector plate or pin plate. In this way the hydraulic actuator is connected to the ejector plate without the necessity of providing a threaded bore in the pin plate and/or the ejector plate. The coupling is linked to the hydraulic actuator by conduit 58.

The foregoing description and figures are intended as an illustration of the invention, and are not to be construed as containing or implying limitations upon the invention. It will be appreciated that although various aspects of the invention have been described with respect to specific embodiments, alternatives and modifications will be apparent from the present disclosure which are within the spirit and scope of the present invention as set forth in the following claims.

What is claimed:

1. A timing system for use in the manufacture of a stack mold having a center mold portion and a plurality of moveable mold portions which open and close relative to the center portion, the stack mold being adapted for installation in a mold press having a mold press frame, the system comprising:
a gear assembly for attachment to the center portion of the stack mold;
a plurality of racks for slidably mounting to the gear assembly;
a plurality of rack spacers each dimensioned for spacing and mounting said plurality of racks to at least one of said plurality of moveable mold portions; and
a center support for mounting the center mold portion to the mold press frame.

2. The timing system of claim 1 wherein said gear assembly includes an outer housing enclosing the gear assembly.

3. The timing system of claim 1 wherein said gear assembly includes a breakaway dowel pin for rotatably mounting a gear wheel within the gear assembly.

4. The timing system of claim 3 wherein said gear assembly includes at least one roller bearing for rotatably mounting the gear wheel to the dowel pin.

5. The timing system of claim 1 wherein said gear assembly includes a plurality of cam followers rotatably mounted adjacent to the gear wheel for slidably mounting at least one of the plurality of racks between the cam followers and the gear wheel.

6. The timing system of claim 1 wherein said gear housing includes a plurality of voids for receipt of mounting bolt for securing the gear assembly to the center portion of the mold.

7. The timing system of claim 1 wherein at least one of the plurality of racks are mounted to the moveable mold portions by a breakaway dowel pin.

8. The timing system of claim 7 wherein at least one of the plurality of the rack spacers include a pair of U-shaped members for enclosing the rack in a cavity formed therebetween.

9. The timing system in accordance with claim 1 wherein the gear assembly includes a plurality of wear pads positioned within the gear assembly for sliding contact with the plurality of racks, at least one of the plurality of wear pads having a coating providing a low co-efficient of friction and good wear resistance.

10. The timing system of claim 1 wherein each of the plurality of moveable plates includes a hydraulic actuator to drive movement of an ejector plate.

11. The timing system of claim 10 wherein a threadless pin plate coupling having a shoulder for receipt in a retaining slot formed in the ejector plate for connecting the hydraulic actuator with the ejector plate.

12. A stack mold for use in an injection molding press having a press frame comprising:
a mold center portion;
a center portion support for slidably mounting the mold center portion to the press frame;
a gear assembly adapted to mount in a pocket formed in the mold center portion;
a plurality of moveable mold portions which open and close relative to center portion, the moveable mold portions and center portions forming a plurality of mold cavities when held in a closed position;
a plurality of racks having first and second ends, the first ends of the racks being slidably mounted to the gear assembly, the second end of the racks being mounted to one of the plurality of moveable mold portions; and
a plurality of rack spacers for mounting the second end of the plurality of racks to the plurality of moveable mold portions.

13. A stack mold in accordance with claim 12 wherein the gear assembly includes an outer housing and a gear wheel rotatably mounted within the gear assembly.

14. A stack mold in accordance with claim 13 wherein the gear assembly includes a breakaway dowel pin for rotatably mounting the gear wheel to the gear assembly.

15. A stack mold in accordance with claim 12 wherein the gear assembly includes a plurality of wear pads positioned within the gear assembly for sliding contact with the plurality of racks, at least one of the wear pads having a coating providing a low co-efficient of friction and good wear resistance.

16. The stack mold of claim 12 wherein each of the plurality of moveable plates includes a hydraulic actuator to drive movement of an ejector plate.

17. The stack mold of claim 12 wherein a threadless pin plate coupling having a shoulder for receipt in a retaining slot formed in the ejector plate to connect the hydraulic actuator with the ejector plate.

18. The timing system of claim 12 wherein said gear assembly includes a plurality of cam followers rotatably mounted adjacent to the gear wheel for slidably mounting at least one of the plurality of racks between the cam followers and the gear wheel.

19. The stack mold of claim 18 wherein the plurality of rack spacers are secured to the moveable mold portions at no more than two opposing corners of the rack spacers and wherein the spacers are adapted to receive a dowel pin which passes through the rack spacer, moveable rack and into the moveable mold portion.

20. The stack mold of claim 12 wherein the center portion support is adapted to detachably mount to the center support.

21. The stack mold of claim 12 wherein the center support is detachably mounted to the center support by a plurality of threaded bolts and mounted to the press frame by a plurality of detachable tie bar pads.

22. A gear assembly for use in a stack mold having a center portion and a plurality of moveable portions, said gear assembly comprising:
an outer housing;
a gear wheel rotatably mounted to the outer housing; and
a plurality of cam followers spaced apart from said gear wheel and rotatably mounted to said housing.

23. The gear assembly of claim 22 further comprising a breakaway dowel pin mounted to the housing for rotatably mounting the gear wheel.

24. The gear assembly of claim 23 further comprising at least one roller bearing for rotatably mounting the gear wheel to the breakaway dowel pin.

25. The gear assembly of claim 22 wherein the outer housing is adapted to mount in a pocket machined in the center portion of the stack mold.

26. The gear assembly of claim 25 wherein the outer housing has a plurality of bores formed therein for receipt of mounting bolts for mounting the gear assembly to the center portion of the stack mold.

27. The gear assembly of claim 22 further comprising a plurality of cam followers rotatably mounted adjacent to the gear wheel for slidably mounting at least one of the plurality of racks between the cam followers and the gear wheel.

28. The gear assembly in accordance with claim 22 further comprising a plurality of wear pads positioned within the gear assembly for sliding contact with the plurality of racks, at least one of the wear pads having a coating providing a low co-efficient of friction and good wear resistance thereto.
